(19) United States
(12) Patent Application Publication
(10) Pub. No.: US 2013/0091326 A1
(43) Pub. Date: Apr. 11, 2013

(54) SYSTEM FOR PROVIDING USER DATA STORAGE ENVIRONMENT USING NETWORK-BASED FILE SYSTEM IN N-SCREEN ENVIRONMENT

(71) Applicants: Ill Young Choi, Seoul (KR); Heung Soo Park, Namyangju-si (KR)

(72) Inventors: Ill Young Choi, Seoul (KR); Heung Soo Park, Namyangju-si (KR)

(73) Assignees: MINIGATE. CO. LTD., SEOUL (KR); HANWHA SOLUTION & CONSULTING CO., LTD, SEOUL (KR)

(21) Appl. No.: 13/287,889

(22) Filed: Nov. 2, 2011

(30) Foreign Application Priority Data
Oct. 6, 2011 (KR) 10-2011-0101888

(51) Int. Cl. G06F 12/08

(52) U.S. Cl. 711/113; 711/118; 711/E12.019

(57) ABSTRACT

A system for providing a user data storage environment using a network-based file system in an N-screen environment is provided. The system may include a memory cache to store a cache file downloaded from a Network File System (NFS) storage that is equipped in a server and stores data for each user, and an NFS interface to store, in the memory cache, the cache file downloaded through an NFS, in order to use the cache file in the N-screen environment.

### CROSS-REFERENCE TO RELATED APPLICATION

This application claims the priority benefit of Korean Patent Application No. 10-2011-0101888, filed on Oct. 6, 2011, in the Korean Intellectual Property Office, the disclosure of which is incorporated herein by reference.

### BACKGROUND

1. Field

Example embodiments relate to a user data storage environment providing system that may provide an N-screen environment using a network file system.

2. Description of the Related Art

A Network File System (NFS) has been developed for sharing a file system and server resources, and corresponds to a service provided to enable a client to use the server resources as their own personal resources.

A conventional NFS is mostly used in a personal computer (PC) or a server environment, as disclosed in Korean Patent Application Publication No. 10-2010-0039359, published on Apr. 15, 2010 and entitled “SYSTEM AND METHOD OF TRANSPARENT AWARE DATA TRANSFORMATION AT FILE SYSTEM LEVEL.”

However, recently an increasing number of contents are provided through an N-screen environment so that a user may share and execute multiple contents at any time and location, and may resume playing the contents seamlessly.

An N-screen refers to a screen that enables a display of contents that can be viewed using a single screen, through an interaction among multiple screens, for example, N screens.

In order to provide such N-screen environment to the conventional NFS, all recent data is downloaded from a server when the NFS is initialized, and a database or a change history file is generated for tracking changes of a file in the future. Then, a file is transmitted to the server by tracking a file recorded when a program is terminated or when a synchronization request, for example, a request to move a screen, and the like, is received from a user. In this instance, the server determines recent data based on policies, for example, a date, a priority, and the like, and merges or overwrites the file.

However, when the N-screen environment is provided using the foregoing method, the same data is stored in both a local disk and a server, which, as a consequence, results in a waste of storage space. In this instance, numerous problems, for example, data merger and the like occur, since duplicated data is required to be managed. It is also problematic that an initial performance is deteriorated since large recent files are downloaded when the NFS is initialized. In addition, a terminal having a small storage space, for example, a mobile terminal, and the like, fails to flexibly deal with data exceeding a limited capacity of a physical storage space of a user terminal.

Further, when multiple users access the same file system using a public terminal such as a smart TV, and the like, a security problem arises since data of a user is stored in a physical storage space of the terminal, without any changes being made. Finally, there is a problem in that it is difficult to guarantee a function in a mobile terminal in which connection to the network is not guaranteed.

### SUMMARY

The foregoing and/or other aspects are achieved by providing a system for providing a user data storage environment using a network-based file system in an N-screen environment, which may improve an initial performance of a Network File System (NFS), use a storage space more effectively, and provide the N-screen environment to a terminal having a small storage space.

The foregoing and/or other aspects are also achieved by providing a system for providing a user data storage environment using a network-based file system in an N-screen environment, which may ensure security although an N-screen is used in a public terminal, and may provide the N-screen environment to a terminal in which a network connection is not guaranteed, for example, a mobile terminal.

The example embodiments may include a system for providing a user data storage environment in an N-screen environment, the system including a memory cache to store a cache file downloaded from an NFS storage that is equipped in a server and stores data for each user, and an NFS interface to store, in the memory cache, the cache file downloaded through an NFS, in order to use the cache file in the N-screen environment.

The system may further include a disk cache to store, based on a predetermined priority, a cache file used a fewer number of times than a predetermined number of times, among cache files stored in the memory cache. Here, the cache file used the fewer number of times than the predetermined number of times may be deleted from the memory cache.

The disk cache may first store a system file, among the cache files stored in the memory cache, for an operation in an offline state, and may then sequentially store an application executable file, and a general file generated by a user.

The cache file may be stored directly in the NFS storage in an online state.

When the NFS is initialized, the cache file may be downloaded after the NFS allocated to a corresponding user is locked. When a program using the cache file is terminated, the network file system may be unlocked after the cache file is synchronized with the cache file stored in the NFS storage.

Additional aspects of embodiments will be set forth in part in the description which follows and, in part, will be apparent from the description, or may be learned by practice of the disclosure.

### EFFECT

According to example embodiments, an initial performance of a Network File System (NFS) may be improved by reading a file directly from an NFS storage in an online state, a storage space may be more effectively used, and an N-screen environment may be provided to a terminal having a small storage space.

According to example embodiments, although an N-screen is used in a public terminal, security may be ensured by allocating a separate storage space for each user, and an N-screen environment may be provided to a terminal in which a network connection is not guaranteed, for example, a mobile terminal, by first storing a system file in a cache.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a system for providing a user data storage environment according to example embodiments;

FIG. 2 illustrates an operation of initializing in a method of providing a user data storage environment according to example embodiments;

FIG. 3 illustrates an operation of reading a file in a method of providing a user data storage environment according to example embodiments;

FIG. 4 illustrates an operation of storing a file in a method of providing a user data storage environment according to example embodiments;

FIG. 5 illustrates an operation of terminating a program in a method of providing a user data storage environment according to example embodiments; and

FIG. 6 illustrates an operation of processing a main cache file based on determination in a method of providing a user data storage environment according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

According to example embodiments, a system for providing a user data storage environment in an N-screen environment may include a memory cache to store a cache file downloaded from a Network File System (NFS) storage that is equipped in a server and stores data for each user, and an NFS interface to store, in the memory cache, the cache file downloaded through an NFS, in order to use the cache file in the N-screen environment.

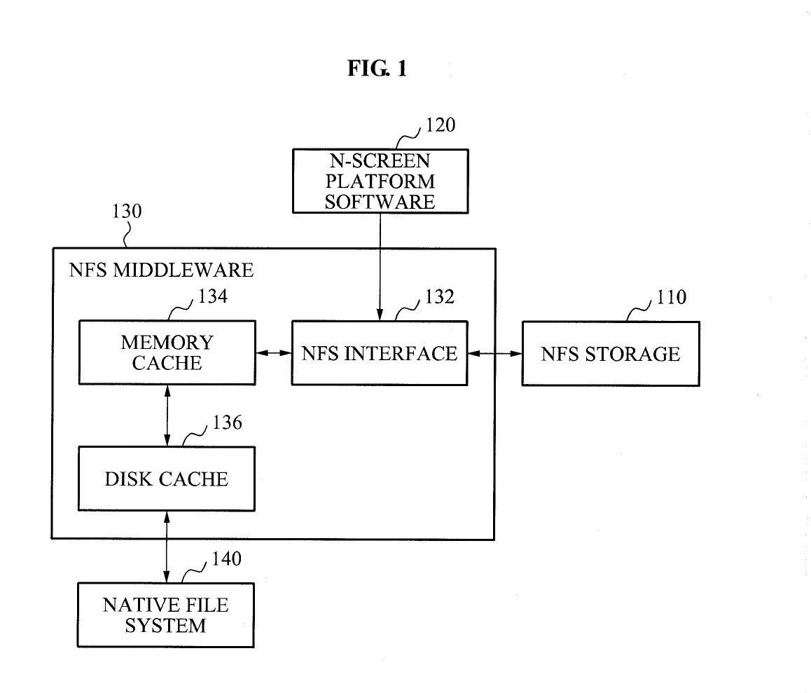

The system for providing the user data storage environment in the N-screen environment will be hereinafter described in detail with reference to FIG. 1.

FIG. 1 illustrates a system for providing a user data storage environment in an N-screen environment according to example embodiments. The system for providing the user data storage environment in the N-screen environment will be hereinafter referred to as the ‘system.’

The system may include an NFS storage 110, N-screen platform software 120, NFS middleware 130, and a native file system 140. Here, the NFS middleware 130 may include an NFS interface 132, a memory cache 134, and a disk cache 136.

The NFS storage 110 may be equipped in a server, may allocate a separate storage space for each user, and may store all data of a user regardless of a number of screens. Accordingly, security may be ensured although an N-screen in a public terminal is used by a user.

The N-screen platform software 120 may be used to provide the N-screen environment to the user. The N-screen platform software 120 may process a cache file through the NFS middleware 130.

A cache is a part of a main memory or a dedicated small-sized and high-speed memory that is used for improving a performance of a computer. The cache provides locations where data and commands are temporarily stored, between a high-speed Central Processing Unit (CPU) and a main memory with lower speed when compared to the CPU.

When a memory capacity of a cache is great, a probability that required data is already stored in the cache may increase and thus, the performance of the computer may also increase.

In an online state, the cache file may be stored directly in the NFS storage 110, and may be read directly from the NFS storage 110 when reading the file. Accordingly, an initial performance of an NFS may be improved, a storage space may be more efficiently used, and the N-screen environment may be provided to a terminal having a small storage space.

The N-screen platform software 120 may reduce network traffic by retaining the cache file in the memory cache 134 and the disk cache 136 through the NFS interface 132 when the cache file corresponds to a recently used and frequently called file.

The NFS middleware 130 may download the cache file stored in the NFS storage 110 to the memory cache 134 or the disk cache 136, through the NFS interface 132.

The memory cache 134 may store the cache file downloaded from the NFS storage 110 through the NFS interface 132.

The disk cache 136 may assist the memory cache 134, and may also store an important file for enabling an operation of a minimized function of the N-screen platform software 120 in a case of a terminal in which an access to the network is not always guaranteed, for example, a mobile terminal.

The disk cache 136 may store, based on a predetermined priority, a cache file used a fewer number of times than a predetermined number of times, among cache files stored in the memory cache 134. In this instance, the cache file used the fewer number of times than the predetermined number of times may be deleted from the memory cache 134.

In the disk cache 136, a system file, among the cache files stored in the memory cache 134, may first be stored for an operation in an offline state, and then an application executable file, and a general file generated by a user may be stored sequentially.

A general file system only stores data most frequently used in a cache since the general file system is aimed only at a performance. However, the system according to example embodiments may first store a system file in a cache, thereby increasing an accuracy rate of files to be stored in the cache, and enabling a system of a terminal to be operated although the terminal is offline. Accordingly, the N-screen environment may be provided to a terminal in which a network connection is not guaranteed, for example, a mobile terminal.

As an example, the disk cache 136 may mainly store files having a high importance based on a priority, for example, in a sequential order starting from a system file, an application executable file, and a general file generated by the user, rather than copying entire data of the NFS storage 110.

When the NFS is initialized, the cache file may be downloaded after the NFS allocated to a corresponding user is locked. Also, when a program using the cache file is terminated, the network file system may be unlocked after the cache file is synchronized with the cache file stored in the NFS storage 110.

The native file system 140 may correspond to a file system that is basically used in an operating system of a terminal, and may vary depending on a type of the operating system.

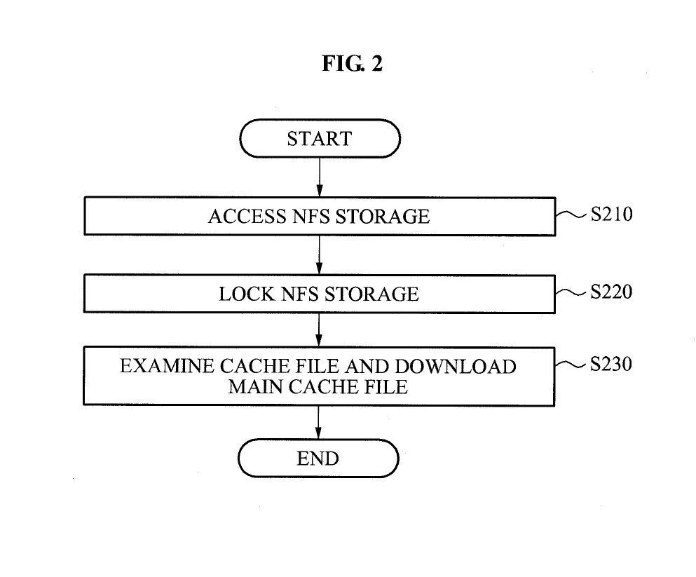

Each operation of providing a user data storage environment in an N-screen environment will be described with reference to FIGS. 2 through 6.

FIG. 2 illustrates an operation of initializing in a method of providing a user data storage environment according to example embodiments.

In an operation of initializing an NFS, an access to an NFS storage is performed in operation S210, and a file system allocated to a corresponding user may be locked in operation S220. A main cache file may be determined by examining cache files, and selected cache files may be downloaded first in operation S230. In this instance, the files may be downloaded in a sequential order, starting from a system file, an application executable file, and a general file.

The system file may be recorded in a disk cache with a highest priority since the system file may have a relatively high frequency of reuse when compared to the other files, and there may be devastating effects to a system operation when the system file fails to be downloaded normally, resulting from a network problem, and the like.

The disk cache may be computed dynamically based on an environment of a terminal, to for example, whether a disk is available, a network disconnection frequency, and the like. The disk cache may be unnecessary for a fixed terminal in which a network connection is guaranteed, for example, a smart TV.

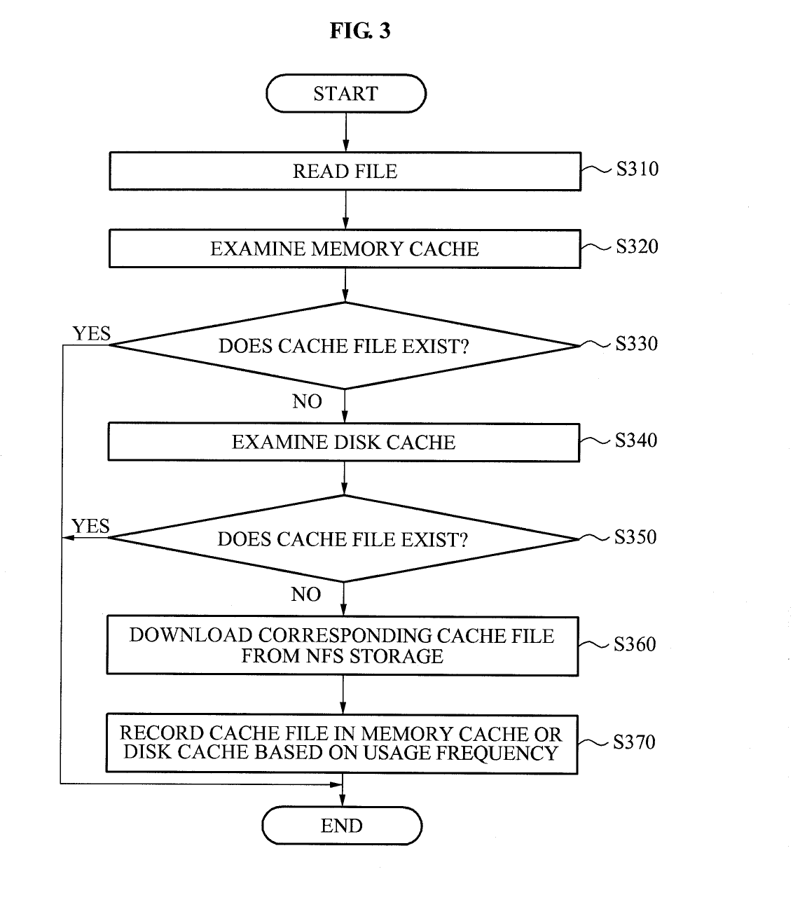

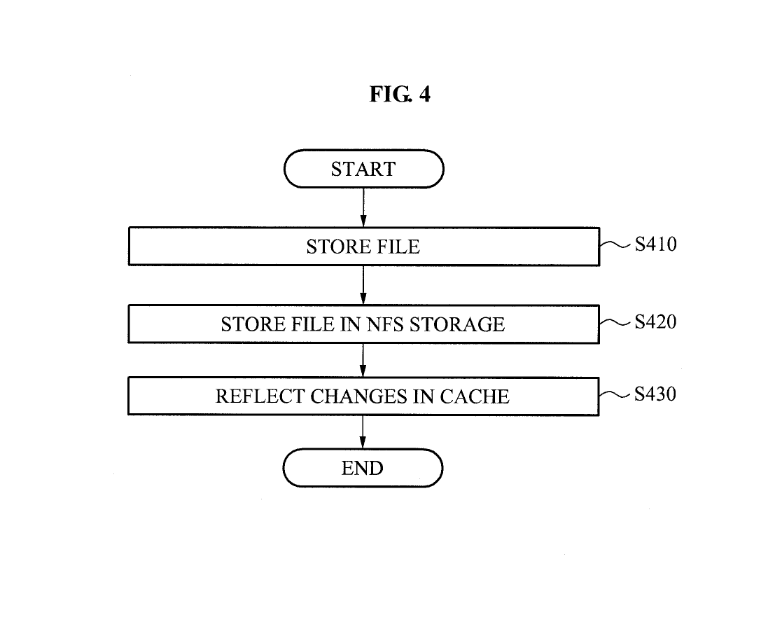

FIG. 3 illustrates an operation of reading a file in a method of providing a user data storage environment according to example embodiments, and FIG. 4 illustrates an operation of storing a file in a method of providing a user data storage environment according to example embodiments.

Referring to FIG. 3, when reading of a file is performed in operation S310, whether a corresponding file exists in a memory cache may be examined in operation S320. When a cache file is absent from the memory cache in operation S330, whether the corresponding file exists in a disk cache may be examined in operation 5340. When the cache file is also absent from the disk cache in operation S350, the corresponding cache file may be downloaded from an NFS storage in operation 5360. The corresponding cache file may be recorded in the memory cache or the disk cache based on a frequency of usage in operation S370.

Referring to FIG. 4, when storing a file is performed in operation S410, the file may be stored directly in an NFS storage in operation S420 in a case where a corresponding file neither exists in a memory cache nor a disk cache as a result of verifying whether the corresponding file exists in the memory cache or the disk cache. The file stored in the NFS storage in operation S420 may also be stored in the memory cache, whereby changes be reflected in the memory cache in operation S430.

Here, a cache file that is rarely used may be removed from the memory cache, and may be moved to the disk cache. In this instance, a file that does not have devastating effects on a system operation, for example, a file generated by a user, may be stored in the disk cache with a lowest priority.

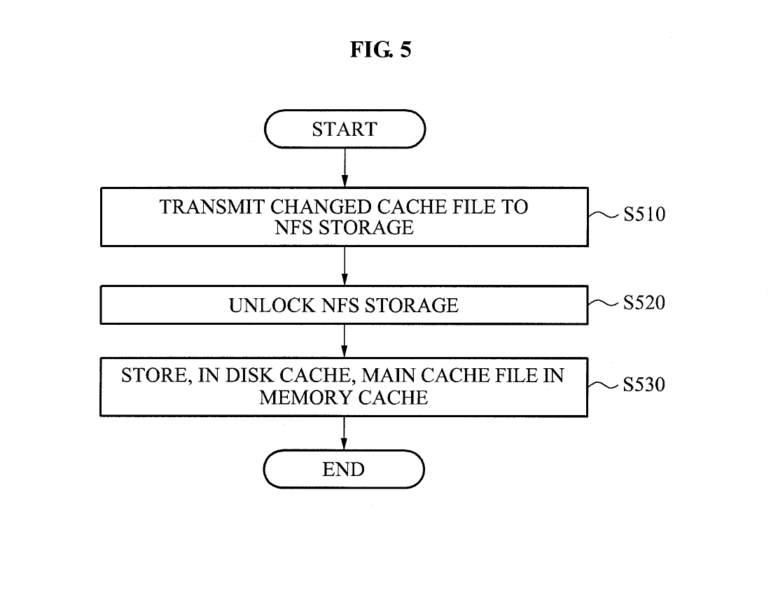

FIG. 5 illustrates an operation of terminating a program in a method of providing a user data storage environment according to example embodiments.

When the program is terminated, a changed cache file stored in a memory cache or a disk cache may be synchronized by examining changes of the changed cache which fails to be transmitted to a server, and then transmitting the changes to an NFS storage, in operation S510. The NFS storage may be unlocked in operation S520. A main cache file in the memory cache, for example, a system file, may be stored in the disk cache in operation S530 so that a user may access the stored main cache file through another screen in the future, and a minimum function may be performed although a terminal is offline.

An operation of processing a main cache file based on determination will be described hereinafter in more detail.

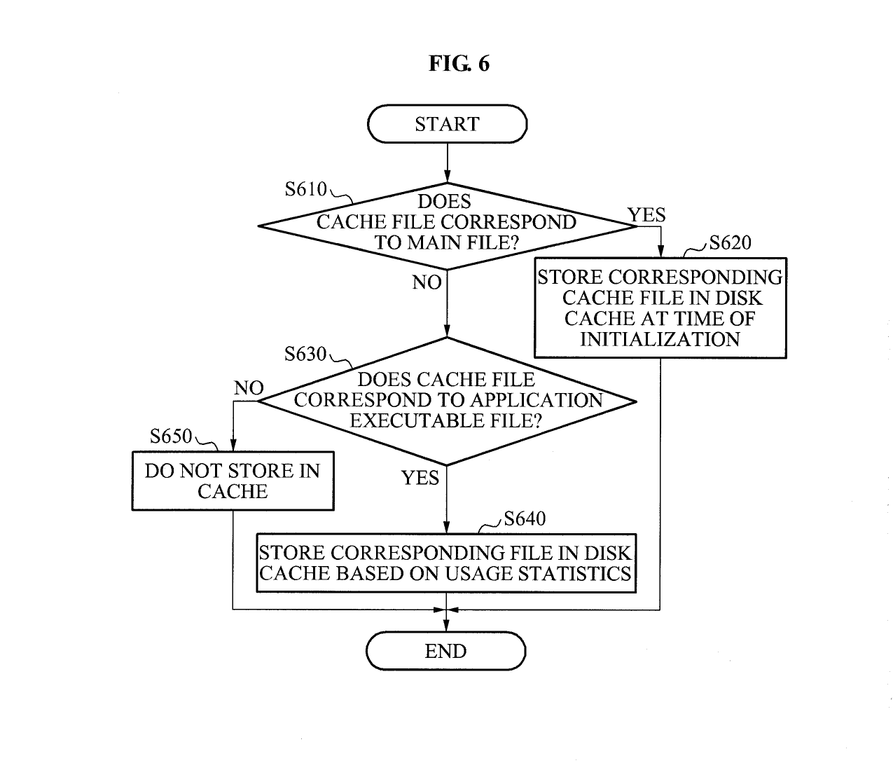

FIG. 6 illustrates an operation of processing a main cache file based on determination in a method of providing a user data storage environment according to example embodiments.

A system for providing a user data storage environment in an N-screen environment, hereinafter referred to as the system, may determine whether a cache file to be stored corresponds to a main executable file in operation 5610. If the cache file to be stored corresponds to a main executable file, the system may store the corresponding cache file in a disk cache in operation 5620 when an NFS is initialized. When the cache file to be stored fails to correspond to a main executable file, the system may determine whether the cache file corresponds to an application executable file in operation S630. If the cache file corresponds to an application executable file, the system may store the corresponding cache file in the disk cache in operation 5640 when the corresponding cache file corresponds to a file used frequently, for example, a number of times more than a predetermined number of times, based on usage statistics of the corresponding cache file. However, when the cache file corresponds to neither the main executable file nor the application executable file, the system may determine the corresponding cache file to be a general file generated by the user, and accordingly may not store the corresponding cache file in the memory cache or the disk cache in operation S650.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. A system for providing a user data storage environment in an N-screen environment, the system comprising:
a memory cache to store a cache file downloaded from a Network File System (NFS) storage that is equipped in a server and stores data for each user; and
an NFS interface to store, in the memory cache, the cache file downloaded through an NFS, in order to use the cache file in the N-screen environment.

2. The system of claim 1, further comprising:
a disk cache to store, based on a predetermined priority, a cache file used a fewer number of times than a predetermined number of times, among cache files stored in the memory cache,
wherein the cache file used the fewer number of times than the predetermined number of times is deleted from the memory cache.

3. The system of claim 2, wherein the disk cache first stores a system file, among the cache files stored in the memory cache, for an operation in an offline state, and then sequentially stores an application executable file, and a general file generated by a user.

4. The system of claim 1, wherein the cache file is stored directly in the NFS storage in an online state.

5. The system of claim 1, wherein
when the NFS is initialized, the cache file is downloaded after the NFS allocated to a corresponding user is locked, and
when a program using the cache file is terminated, the network file system is unlocked after the cache file is synchronized with the cache file stored in the NFS storage.
